(19) United States
(12) Patent Application Publication
(10) Pub. No.: US 2007/0034615 A1
(43) Pub. Date: Feb. 15, 2007

(54) Fabricating medical devices with an ytterbium tungstate laser

(76) Inventor: Klaus Kleine, Los Gatos, CA (US)

Correspondence Address: SQUIRE, SANDERS & DEMPSEY LLP, 1 MARITIME PLAZA, SUITE 300, SAN FRANCISCO, CA, 94111, US

(21) Appl. No.: 11/205,269

(22) Filed: Aug. 15, 2005

(51) Int. Cl. B23K 26/38

(52) U.S. Cl. 219/121.72

(57) ABSTRACT

Methods for fabricating a stent using a femtosecond laser with an Ytterbium Tungstate active medium are disclosed. In some embodiments, a method includes forming a pattern in the substrate with the laser, the pattern including a plurality of structural elements.

### BACKGROUND OF THE INVENTION

1. Field of the Invention

This invention relates to laser machining for use in fabricating devices. In particular, the invention relates to fabricating implantable medical devices such as stents using a femtosecond Ytterbium Tungstate laser.

2. Description of the State of the Art

This invention relates to laser machining of devices such as stents. Laser machining refers to removal of material accomplished through laser and target material interactions. Generally speaking, these processes include laser drilling, laser cutting, and laser grooving, marking or scribing. Laser machining processes transport photon energy into a target material in the form of thermal energy or photochemical energy. Material is removed by melting and blow away, or by direct vaporization/ablation.

The application of ultrashort-pulse lasers for high quality laser material processing is particularly useful due to the extremely high intensity (>10¹² W/cm²), ultrashort-pulse duration (<1 picosecond), and non-contact nature of the processing. Ultrashort-pulse lasers allow precise and efficient processing, especially at the microscale. Compared with long-pulse lasers and other conventional manufacturing techniques, ultrashort lasers provide precise control of material removal, can be used with an extremely wide range of materials, produce negligible thermal damage, and provide the capability for very clean small features. These features make ultrashort-pulse lasers a promising tool for microfabrication, thin film formation, laser cleaning, and medical and biological applications.

However, laser machining of a substrate tends to result in a heat affected zone. The heat affected zone is a region on the target material that is not removed, but is adversely affected by heat due to the laser. The properties of material in the zone can be adversely affected by heat from the laser. Therefore, it is generally desirable to reduce or eliminate input of heat beyond removed material, thus reducing or eliminating the heat affected zone.

One of the many medical applications for laser machining includes fabrication of radially expandable endoprostheses, which are adapted to be implanted in a bodily lumen. An “endoprosthesis” corresponds to an artificial device that is placed inside the body. A “lumen” refers to a cavity of a tubular organ such as a blood vessel.

A stent is an example of such an endoprosthesis. Stents are generally cylindrically shaped devices, which function to hold open and sometimes expand a segment of a blood vessel or other anatomical lumen such as urinary tracts and bile ducts. Stents are often used in the treatment of atherosclerotic stenosis in blood vessels. “Stenosis” refers to a narrowing or constriction of the diameter of a bodily passage or orifice. In such treatments, stents reinforce body vessels and prevent restenosis following angioplasty in the vascular system. “Restenosis” refers to the reoccurrence of stenosis in a blood vessel or heart valve after it has been treated (as by balloon angioplasty, stenting, or valvuloplasty) with apparent success.

The treatment of a diseased site or lesion with a stent involves both delivery and deployment of the stent. “Delivery” refers to introducing and transporting the stent through a bodily lumen to a region, such as a lesion, in a vessel that requires treatment. “Deployment” corresponds to the expanding of the stent within the lumen at the treatment region. Delivery and deployment of a stent are accomplished by positioning the stent about one end of a catheter, inserting the end of the catheter through the skin into a bodily lumen, advancing the catheter in the bodily lumen to a desired treatment location, expanding the stent at the treatment location, and removing the catheter from the lumen.

In the case of a balloon expandable stent, the stent is mounted about a balloon disposed on the catheter. Mounting the stent typically involves compressing or crimping the stent onto the balloon. The stent is then expanded by inflating the balloon. The balloon may then be deflated and the catheter withdrawn. In the case of a self-expanding stent, the stent may be secured to the catheter via a retractable sheath or a sock. When the stent is in a desired bodily location, the sheath may be withdrawn which allows the stent to self-expand.

The stent must be able to satisfy a number of mechanical requirements. First, the stent must be capable of withstanding the structural loads, namely radial compressive forces, imposed on the stent as it supports the walls of a vessel. Therefore, a stent must possess adequate radial strength. Radial strength, which is the ability of a stent to resist radial compressive forces, is due to strength and rigidity around a circumferential direction of the stent. Radial strength and rigidity, therefore, may also be described as, hoop or circumferential strength and rigidity.

Once expanded, the stent must adequately maintain its size and shape throughout its service life despite the various forces that may come to bear on it, including the cyclic loading induced by the beating heart. For example, a radially directed force may tend to cause a stent to recoil inward. Generally, it is desirable to minimize recoil.

In addition, the stent must possess sufficient flexibility to allow for crimping, expansion, and cyclic loading. Longitudinal flexibility is important to allow the stent to be maneuvered through a tortuous vascular path and to enable it to conform to a deployment site that may not be linear or may be subject to flexure. Finally, the stent must be biocompatible so as not to trigger any adverse vascular responses.

The structure of a stent is typically composed of scaffolding that includes a pattern or network of interconnecting structural elements often referred to in the art as struts or bar arms. The scaffolding can be formed from wires, tubes, or sheets of material rolled into a cylindrical shape. The scaffolding is designed so that the stent can be radially compressed (to allow crimping) and radially expanded (to allow deployment).

Stents have been made of many materials such as metals and polymers, including biodegradable polymeric materials. Biodegradable stents are desirable in many treatment applications in which the presence of a stent in a body may be necessary for a limited period of time until its intended function of, for example, achieving and maintaining vascular patency and/or drug delivery is accomplished.

Stents can be fabricated by forming patterns on tubes or sheets using laser cutting. Laser machining is well-suited to forming the fine intricate patterns of structural elements in stents. However, the use of laser machining to fabricate stents can result in a heat affected zone in which mechanical and other properties have been adversely affected by the laser machining process. Therefore, it is also desirable to reduce or eliminate the heat affected zone resulting from laser machining processes of stents.

### SUMMARY OF THE INVENTION

Certain embodiments of the present invention are directed to a method of fabricating a stent that may include providing a substrate; providing a femtosecond laser with an Yb:KGW active medium; and forming a pattern in the substrate with the laser such that the pattern includes a plurality of structural elements.

### BRIEF DESCRIPTION OF THE DRAWINGS

FIG. 1 depicts a mathematical representation of a Gaussian beam profile.

FIG. 2 depicts a collimated two-dimensional representation of a laser beam.

FIG. 3 depicts an overhead view of the surface of a substrate.

FIG. 4 illustrates a kerf machined by a laser.

FIG. 5 depicts a general schematic of a laser system.

FIG. 6 depicts an exemplary set-up for a mode-locked Yb:KGW laser.

FIG. 7 depicts a three-dimensional representation of a stent.

FIG. 8 is an elevation view, partially in section, of a stent which is mounted on a rapid-exchange delivery catheter and positioned within an artery.

FIG. 9 is an elevation view, partially in section, similar to that shown in FIG. 1, wherein the stent is expanded within the artery so that the stent embeds within the arterial wall.

FIG. 10 is an elevation view, partially in section, showing the expanded stent implanted within the artery after withdrawal of the rapid-exchange delivery catheter.

FIG. 11 depicts an embodiment of a portion of a machine-controlled system for laser machining a tube.

FIG. 12 depicts a side view of a laser machining apparatus.

FIG. 13 depicts an overhead view of a laser machining apparatus.

FIG. 14 depicts a close-up axial view of a region where a laser beam interacts with a tube.

FIG. 15 depicts a close-up end view of a region where a laser beam interacts with a tube.

### DETAILED DESCRIPTION OF THE INVENTION

Embodiments of the present invention employ femtosecond ultrashort-pulse lasers in laser machining of substrates. These embodiments are suitable for fabricating fine and intricate structures of implantable medical devices such as stents. Laser machining may be applied in fabricating implantable medical devices including, but not limited to, self-expandable stents, balloon-expandable stents, stent-grafts, and vascular grafts.

“Ultrashort-pulse lasers” refer to lasers having pulses with durations shorter than about a picosecond (=10⁻¹²). Ultrashort-pulse lasers can include both picosecond and femtosecond (=10⁻¹⁵) lasers. The ultrashort-pulse laser is clearly distinguished from conventional continuous wave and long-pulse lasers (nanosecond (10⁻⁹) laser) which have significantly longer pulses.

In particular, as discussed below, embodiments of the present method employ a femtosecond laser with an Ytterbium-doped active medium. Femtosecond lasers may have pulses shorter than about 10⁻¹³ second.

Ultrashort-pulse lasers are known to artisans. For example, they are thoroughly disclosed by M. D. Perry et al. in Ultrashort-Pulse Laser Machining, Section K-ICALEO 1998, pp. 1-20. Representative examples of femtosecond lasers include, but are not limited to a Ti:sapphire laser (735 nm-1035 nm) and an excimer-dye laser (220 nm-300 nm, 380 nm-760 nm).

Longer-pulse lasers remove material from a surface principally through a thermal mechanism. The laser energy that is absorbed results in a temperature increase at and near the absorption site. As the temperature increases to the melting or boiling point, material is removed by conventional melting or vaporization. Depending on the pulse duration of the laser, the temperature rise in the irradiated zone may be very fast resulting in thermal ablation and shock.

An advantage of ultrashort-pulse lasers over longer-pulse lasers is that the ultrashort-pulse deposits its energy so fast that is does not interact with the plume of vaporized material, which would distort and bend the incoming beam and produce a rough-edged cut. Unlike long-pulse lasers, ultrashort-pulse lasers allow material removal by a nonthermal mechanism. Extremely precise and rapid machining can be achieved with essentially no thermal ablation and shock.

Even ultrashort-pulse laser machining tends to result in a heat affected zone, i.e., a portion of the target substrate that is not removed, but is still heated by the beam. The heating may be due to exposure of the substrate from a section of the beam with an intensity that is not great enough to remove substrate material through either a thermal or nonthermal mechanism. Lasers typically emit pulses that have a nonuniform intensity profile across a radial cross-section. For example, the profile may have the characteristic shape of a Gaussian distribution.

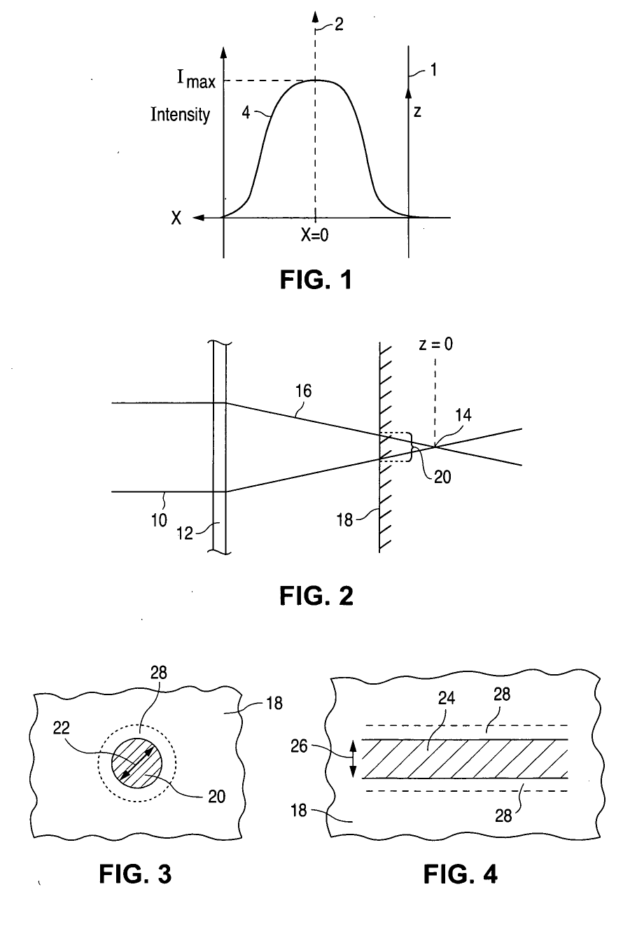

FIG. 1 depicts an axial cross-section of a laser beam 1 traveling in the “z” direction as indicated by an arrow 2. A mathematical representation 4 of the intensity, I (e.g., W/m²), in the form of a Gaussian beam profile is shown superimposed on the beam. The profile has a maximum (Iₘₐₓ) at the beam center (x=0) and then decreases with distance on either side of the maximum. The sections of the beam close to the edge may not remove material. However, such sections may still deposit energy into the material that can have undesirable thermal affects. Additionally, a portion of the substrate may also be heated through conduction.

A heat affected zone in a target substrate is undesirable for a number of reasons. In both metals and polymers, heat can cause thermal distortion and roughness at the machined surface. The heat can also alter properties of a polymer such as mechanical strength and degradation rate. The heat can cause chemical degradation that can affect the mechanical properties and degradation rate.

Additionally, heat can modify molecular structure of a polymer, such as degree of crystallinity and polymer chain alignment. Mechanical properties are highly dependent on molecular structure. For example, a high degree of crystallinity and/or polymer chain alignment is associated with a stiff, high modulus material. Heating a polymer above its melting point can result in an undesirable increase or decrease in crystallinity and an undesirable decrease in polymer chain alignment.

In addition, since heat from the laser modifies the properties of the substrate locally, the mechanical properties may be spatially nonuniform. Such nonuniformity may lead to mechanical instabilities such as cracking.

FIGS. 2-4 are schematic illustrations of laser machining a substrate. FIG. 2 depicts a collimated two-dimensional representation of a laser beam 10 passing through a focusing lens 12 with a focal point 14. A focused laser beam 16 decreases in diameter with distance from lens 12. Beam 16 impinges on a substrate 18. An area 20 corresponds to the region of direct interaction of the laser.

FIG. 3 depicts an overhead view of the surface of substrate 18 showing area 20 which has a diameter 22. Laser beam 10 removes material in area 20. FIG. 4 illustrates that translation of the laser beam or substrate allows the laser beam to cut a trench or kerf 24 with a width 26 which is the same as diameter 22. Material in region 28 is not removed, however, is heated by the beam. Region 28 corresponds to a heat affected zone.

Furthermore, the intensity of a pulse is also typically dependent on both time (t) and the axial distance along the beam (z). The intensity, I(z, t), may be separated into a temporal pulse, P(t), and position dependent irradiated area, A(z). P(t) may also have the characteristic form of a Gaussian distribution with a maximum at a peak power, Pₘₐₓ.

One way of reducing or eliminating the heat affected zone is a short pulse coupled with a high peak power. As indicated above, femtosecond lasers emit ultrashort-pulses in the range of 10⁻¹³ seconds with high peak power. Representative examples of femtosecond lasers include, but are not limited to a Ti:sapphire laser (735 nm-1035 nm) and an excimer-dye laser (220 nm-300 nm, 380 nm-760 nm). A Ti:sapphire laser can emit pulses in the range 10 to 100 fs.

Another important characteristic of lasers is how efficiently they operate. The operating efficiency of a laser may be defined as its optical output power, Pₗₐₛₑᵣ, divided by its electrical input power, Pᵢₙ:
Operating efficiency=Pₗₐₛₑᵣ/Pᵢₙ
or
% Efficiency=Pₗₐₛₑᵣ/Pᵢₙ*100%

Achieving a high overall laser device efficiency is critical to minimizing the volume and weight of a high-power laser. Furthermore, since many applications require long-range propagation, any deviation from an ideal output beam effectively reduces the practical device efficiency by a beam quality factor. It is therefore particularly important to minimize thermo-optic effects that degrade beam quality. Required run times, ranges, output-aperture sizes, beam quality, powers, and other system-related factors can be traded off to some extent against device size, but in most cases, the thermal management subsystem still constrains packaging and integration options.

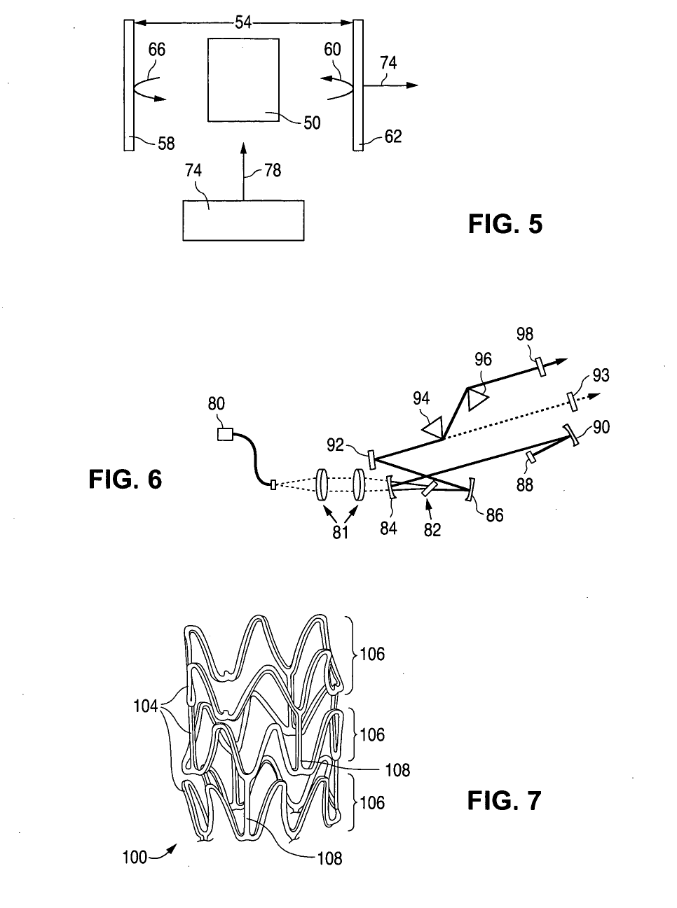

FIG. 5 depicts a general schematic of a laser system that may be used for laser machining of stents. FIG. 5 includes an active medium 50 within a laser cavity 54. An active medium includes a collection of atoms or molecules that are stimulated to a population inversion which can emit electromagnetic radiation in a stimulated emission. Active medium 50 is situated between a highly reflective mirror 58 and an output mirror 62 that reflects and absorbs a laser pulse between the mirrors. Arrows 60 and 66 depict reflected laser pulses between the cavity. Arrow 74 depicts the laser pulse transmitted through output mirror 62. A power source 74 supplies energy or pumps active medium 50 as shown by an arrow 78 so that the active medium can amplify the intensity of light that passes through it.

A laser may be pumped in a number of ways, for example, optically, electrically, or chemically. Optical pumping may use either continuous or pulsed light emitted by a powerful lamp or a laser beam. Diode pumping is one type of optical pumping. A laser diode is a semiconductor laser in which the gain or amplification is generated by an electrical current flowing through a p-n junction. Laser diode pumping can be desirable since efficient and high-power diode lasers have been developed and are widely available in many wavelengths.

Yb-doped materials tend to be attractive for use as active media for laser diode-pumped femtosecond lasers since they have broad emission spectra. The broad emission spectra makes these materials very suitable for ultrashort-pulse generation. Yb-doped potassium tungstates have been shown to exhibit large emission and absorption cross sections, broad emission band-widths, and good thermal conductivities. 100-fs diode-pumped Yb-KGW mode-locked laser, G. Paunescu, J. Hein, R. Sauerbrey, Appl. Phys. B 79, 555-558 (2004). These are very promising properties for constructing efficient femtosecond lasers.

In certain embodiments, a method of laser machining stents may include using a femtosecond laser having an Yb:KGW material for an active medium. In some embodiments, a method of fabricating a stent may include providing a substrate. The substrate may be, for example, a tubular member or a sheet. The method may further include providing a femtosecond laser with an Yb:KGW active medium. A pattern may then be formed in the substrate with the laser such that the pattern has a plurality of structural elements. In the case of a sheet, a stent may be formed from the patterned sheet.

The laser according to one embodiment may have a laser pulse length that is between about 100 and 1000 femtoseconds. The average laser power may be between about 0.01 W and about 4 W. Additionally, the laser pulse frequency may be between about 100 and 5000 Hz. In one embodiment, the laser may be a fixed wavelength at or about 1050 nm. In some embodiments, the laser may be frequency doubled to reduce the wavelength to, for example, at or about 525 nm. A shorter wavelength tends to be more easily absorbed by materials such as polymers.

It is believed that the efficiency of the Yb:KGW laser may be between two and four times that of other femtosecond lasers, such as Ti:Sapphire lasers, operating near the specified wavelength. The reason is that Yb-KGW can convert laser diode light directly into femtosecond laser pulses at or about 1050 nm. In a Ti:Sapphire laser, on the other hand, the active medium cannot convert laser diode light near this wavelength into femtosecond pulses. Diode light is converted to 1064 nm, for example, and then is converted to femtosecond laser pulses. Energy is lost in the conversion to the desired wavelength. Additional energy can then be lost in frequency doubling.

In certain embodiments, the laser may be a mode-locked solid state laser with an external amplifier. The laser may be amplified or pumped with a laser diode. In one embodiment, a high brightness fiber-coupled laser diode may be used. In other embodiments, a direct diode may be used that is mounted adjacent to the active medium.

Mode-locking refers to a method for obtaining ultrashort-pulses from a laser. The laser may use either passive or active mode-locking. In mode-locking, a laser cavity includes either an active element (a modulator) or a nonlinear passive element (saturable absorber) which leads to the formation of ultrashort-pulses circulating in the laser cavity. Active mode-locking refers to the use of a modulator and passive mode-locking corresponds to using a saturable absorber. Passive mode-locking may be more desirable since it allows generation of shorter pulses than active mode-locking. A saturable absorber is an optical component with a certain optical loss, which is reduced for high optical intensities.

FIG. 6 depicts an exemplary set-up for a mode-locked Yb:KGW laser. The laser is pumped by a laser diode 80. The pump beam is focused with antireflective-coated achromatic lenses 81. A beam is amplified by an Yb:KGW active medium crystal 82 situated between curved highly reflective mirrors 84 and 86. Mode-locking is achieved by a saturable absorber mirror (SAM) 88. A curved mirror 90 focuses the laser beam onto SAM 88 at a desired beam radius. Plane mirror 92 focuses the beam to a partially reflective mirror or output coupler 93. Alternatively or additionally, mirror 92 directs the beam through prisms 94 and 96 to output coupler 98. The prisms may help compensate for the group-velocity dispersion introduced by the amplifying medium.

A femtosecond laser with an Yb:KGW active medium as described above may be used in the fabrication of implantable medical devices such as stents. In general, stents can have virtually any structural pattern that is compatible with a bodily lumen in which it is implanted. Typically, a stent is composed of a pattern or network of circumferential rings and longitudinally extending interconnecting structural elements of struts or bar arms. In general, the struts are arranged in patterns, which are designed to contact the lumen walls of a vessel and to maintain vascular patency. A myriad of strut patterns are known in the art for achieving particular design goals. A few of the more important design characteristics of stents are radial or hoop strength, expansion ratio or coverage area, and longitudinal flexibility.

An exemplary structure of a stent is shown in FIG. 7. FIG. 7 depicts a three-dimensional view of a stent 100 which is made up of struts 104. Stent 100 has interconnected cylindrical rings 106 connected by linking struts or links 108. The embodiments disclosed herein are not limited to fabricating stents or to the stent pattern illustrated in FIG. 7. The embodiments are easily applicable to other stent patterns and other devices. The variations in the structure of patterns are virtually unlimited.

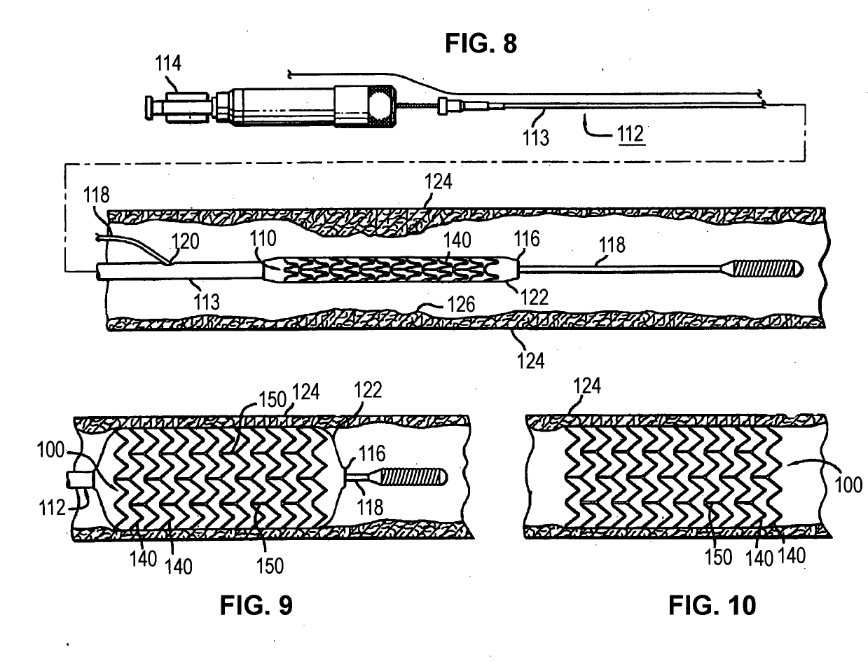

Additionally, an exemplary use of a stent is described in FIGS. 8-10. FIGS. 8-10 can represent any balloon expandable stent 110. FIG. 8 depicts a stent 110 with interconnected cylindrical rings 140 mounted on a catheter assembly 112 which is used to deliver stent 110 and implant it in a bodily lumen. Rings 140 are connected by links 150.

For example, a bodily lumen may include a coronary artery, peripheral artery, or other vessel or lumen within the body. The catheter assembly includes a catheter shaft 113 which has a proximal end 114 and a distal end 116. The catheter assembly is configured to advance through the patient's vascular system by advancing over a guide wire by any of the well-known methods of an over-the-wire system (not shown) or a well-known rapid exchange catheter system, such as the one shown in FIG. 8. The stent 110 in FIGS. 8-10 conceptually represents any type of stent well-known in the art, i.e., one having a plurality of rings 140.

Catheter assembly 112, as depicted in FIG. 8, includes a port 120 where the guide wire 118 exits the catheter. The distal end of guide wire 118 exits catheter distal end 116 so that the catheter advances along the guide wire on a section of the catheter between port 120 and catheter distal end 116. As is known in the art, the guide wire lumen which receives the guide wire is sized for receiving various diameter guide wires to suit a particular application. The stent is mounted on an expandable member 122 (e.g., a balloon) and is crimped tightly thereon, so that the stent and expandable member present a low profile diameter for delivery through the arteries.

As shown in FIG. 8, a partial cross-section of an artery 124 has a small amount of plaque that has been previously treated by angioplasty or other repair procedure. Stent 110 is used to repair a diseased or damaged arterial wall as shown in FIG. 8, or a dissection, or a flap, all of which are commonly found in the coronary arteries and other vessels. Stent 110, and other embodiments of stents, also can be placed and implanted without any prior angioplasty.

In a typical procedure to implant stent 110, guide wire 118 is advanced through the patient's vascular system by well-known methods, so that the distal end of the guide wire is advanced past the plaque or a diseased area 126. Prior to implanting the stent, the cardiologist may wish to perform an angioplasty or other procedure (i.e., atherectomy) in order to open and remodel the vessel and the diseased area. Thereafter, stent delivery catheter assembly 112 is advanced over the guide wire so that the stent is positioned in the target area. The expandable member or balloon 122 is inflated by well-known means so that it expands radially outwardly and in turn expands the stent radially outwardly until the stent is apposed to the vessel wall. The expandable member is then deflated and the catheter withdrawn from the patient's vascular system. The guide wire typically is left in the lumen for post-dilatation procedures, if any, and subsequently is withdrawn from the patient's vascular system. As depicted in FIGS. 9 and 10, the balloon is fully inflated with the stent expanded and pressed against the vessel wall. In FIG. 10, the implanted stent remains in the vessel after the balloon has been deflated and the catheter assembly and guide wire have been withdrawn from the patient.

Stent 110 holds open the artery after the catheter is withdrawn, as illustrated by FIG. 10. A stent may be formed from a cylindrical tube with a constant wall thickness, so that the straight and undulating or curved components of the stent are relatively flat in transverse cross-section. Thus, when the stent is expanded, a flat abluminal surface is pressed into the wall of the artery. As a result, the stent does not interfere with the blood flow through the artery. After the stent is pressed into the wall of the artery, it eventually becomes covered with endothelial cell growth which further minimizes blood flow interference. The undulating or curved portion of the stent provides good tacking characteristics to prevent stent movement within the artery. Because cylindrical rings 140 are closely spaced at regular intervals, they provide uniform support for the wall of the artery. Consequently the rings are well adapted to tack up and hold in place small flaps or dissections in the wall of the artery.

In general, a stent pattern is designed so that the stent can be radially expanded (to allow deployment) and crimped (to allow delivery). The stresses involved during expansion from a low profile to an expanded profile are generally distributed throughout various structural elements of the stent pattern. As a stent expands, various portions of the stent can deform to accomplish a radial expansion.

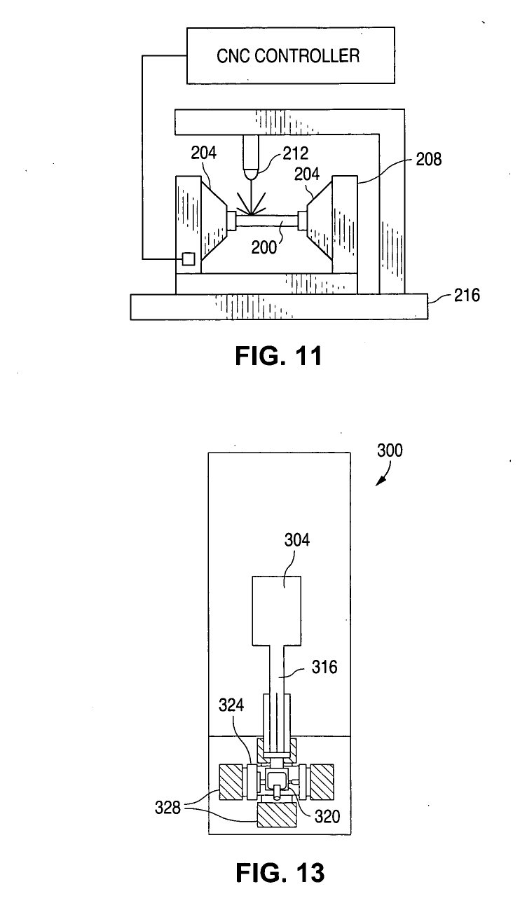

Stents and similar stent structures can be made in a variety of ways. A stent may be fabricated by machining a thin-walled tubular member with a laser. Selected regions of the tubing may be removed by laser machining to obtain a stent with a desired pattern. Alternatively, a stent may be fabricated by machining a sheet in a similar manner, followed by rolling and bonding the cut sheet to form the stent. The tubing may be cut using a machine-controlled laser as illustrated schematically in FIG. 11.

In some embodiments, the outer diameter of a fabricated stent in an unexpanded condition may be between about 0.2 mm and about 5.0 mm, or more narrowly between about 1 mm and about 3 mm. In an embodiment, the length of the stents may be between about 7 mm and about 9 mm, or more narrowly, between about 7.8 and about 8.2 mm.

Laser machining may used to fabricate stents from a variety of materials. For example, stent patterns may be cut into materials including polymers, metals, or a combination thereof. In particular, polymers can be biostable, bioabsorbable, biodegradable, or bioerodable. Biostable refers to polymers that are not biodegradable. The terms biodegradable, bioabsorbable, and bioerodable, as well as degraded, eroded, and absorbed, are used interchangeably and refer to polymers that are capable of being completely eroded or absorbed when exposed to bodily fluids such as blood and can be gradually resorbed, absorbed, and/or eliminated by the body. In addition, a medicated stent may be fabricated by coating the surface of the stent with an active agent or drug, or a polymeric carrier including an active agent or drug. An active agent can also be incorporated into the scaffolding of the stent.

A stent made from a biodegradable polymer is intended to remain in the body for a duration of time until its intended function of, for example, maintaining vascular patency and/or drug delivery is accomplished. After the process of degradation, erosion, absorption, and/or resorption has been completed, no portion of the biodegradable stent, or a biodegradable portion of the stent will remain. In some embodiments, very negligible traces or residue may be left behind. The duration can be in a range from about a month to a few years. However, the duration is typically in a range from about six to twelve months.

Representative examples of polymers that may be used to fabricate embodiments of implantable medical devices disclosed herein include, but are not limited to, poly(N-acetylglucosamine) (Chitin), Chitosan, poly(3-hydroxyvalerate), poly(lactide-co-glycolide), poly(3-hydroxybutyrate), poly(4-hydroxybutyrate), poly(3-hydroxybutyrate-co-3-hydroxyvalerate), polyorthoester, polyanhydride, poly(glycolic acid), poly(glycolide), poly(L-lactic acid), poly(L-lactide), poly(D,L-lactic acid), poly(D,L-lactide), poly(L-lactide-co-D,L-lactide), poly(caprolactone), poly(L-lactide-co-caprolactone), poly(D,L-lactide-co-caprolactone), poly(glycolide-co-caprolactone), poly(trimethylene carbonate), polyester amide, poly(glycolic acid-co-trimethylene carbonate), co-poly(ether-esters) (e.g. PEO/PLA), polyphosphazenes, biomolecules (such as fibrin, fibrinogen, cellulose, starch, collagen and hyaluronic acid), polyurethanes, silicones, polyesters, polyolefins, polyisobutylene and ethylene-alphaolefin copolymers, acrylic polymers and copolymers other than polyacrylates, vinyl halide polymers and copolymers (such as polyvinyl chloride), polyvinyl ethers (such as polyvinyl methyl ether), polyvinylidene halides (such as polyvinylidene chloride), polyacrylonitrile, polyvinyl ketones, polyvinyl aromatics (such as polystyrene), polyvinyl esters (such as polyvinyl acetate), acrylonitrile-styrene copolymers, ABS resins, polyamides (such as Nylon 66 and polycaprolactam), polycarbonates, polyoxymethylenes, polyimides, polyethers, polyurethanes, rayon, rayon-triacetate, cellulose, cellulose acetate, cellulose butyrate, cellulose acetate butyrate, cellophane, cellulose nitrate, cellulose propionate, cellulose ethers, and carboxymethyl cellulose. Additional representative examples of polymers that may be especially well suited for use in fabricating embodiments of implantable medical devices disclosed herein include ethylene vinyl alcohol copolymer (commonly known by the generic name EVOH or by the trade name EVAL), poly(butyl methacrylate), poly(vinylidene fluoride-co-hexafluoropropene) (e.g., SOLEF 21508, available from Solvay Solexis PVDF, Thorofare, N.J.), polyvinylidene fluoride (otherwise known as KYNAR, available from ATOFINA Chemicals, Philadelphia, Pa.), ethylene-vinyl acetate copolymers, poly(vinyl acetate), styrene-isobutylene-styrene triblock copolymers, and polyethylene glycol.

Additionally, stents may also be composed partially or completely of a biostable or bioerodible metal. Some metals are considered bioerodible since they tend to erode or corrode relatively rapidly when exposed to bodily fluids. Biostable metals refer to metals that are not bioerodible. Biostable metals have negligible erosion or corrosion rates when exposed to bodily fluids. Representative examples of biodegradable metals that may be used to fabricate a stent may include, but are not limited to, magnesium, zinc, and iron.

Representative examples of metallic material or an alloy that may be used for fabricating a stent include, but are not limited to, cobalt chromium alloy (ELGILOY), stainless steel (316L), high nitrogen stainless steel, e.g., BIODUR 108, cobalt chrome alloy L-605, “MP35N,” “MP20N,” ELASTINITE (Nitinol), tantalum, nickel-titanium alloy, platinum-iridium alloy, gold, magnesium, or combinations thereof. “MP35N” and “MP20N” are trade names for alloys of cobalt, nickel, chromium and molybdenum available from Standard Press Steel Co., Jenkintown, Pa. “MP35N” consists of 35% cobalt, 35% nickel, 20% chromium, and 10% molybdenum. “MP20N” consists of 50% cobalt, 20% nickel, 20% chromium, and 10% molybdenum.

For example, a stainless steel tube or sheet may be Alloy type: 316L SS, Special Chemistry per ASTM F138-92 or ASTM F139-92 grade 2. Special Chemistry of type 316L per ASTM F138-92 or ASTM F139-92 Stainless Steel for Surgical Implants in weight percent. An exemplary weight percent may be as follows: Carbon (C) 0.03% max; Manganese (Mn): 2.00% max; Phosphorous (P): 0.025% max.; Sulphur (S): 0.010% max.; Silicon (Si): 0.75% max.; Chromium (Cr): 17.00-19.00%; Nickel (Ni): 13.00-15.50%; Molybdenum (Mo): 2.00-3.00%; Nitrogen (N): 0.10% max.; Copper (Cu): 0.50% max.; Iron (Fe): Balance.

FIG. 11 depicts an embodiment of a portion of a machine-controlled system for laser machining a tube. In FIG. 11, a tube 200 is disposed in a rotatable collet fixture 204 of a machine-controlled apparatus 208 for positioning tubing 200 relative to a laser 212. According to machine-encoded instructions, tube 200 is rotated and moved axially relative to laser 212 which is also machine-controlled. The laser selectively removes the material from the tubing resulting in a pattern cut into the tube. The tube is therefore cut into the discrete pattern of the finished stent.

The process of cutting a pattern for the stent into the tubing is automated except for loading and unloading the length of tubing. Referring again to FIG. 11, it may be done, for example, using a CNC-opposing collet fixture 204 for axial rotation of the length of tubing. Collet fixture 204 may act in conjunction with a CNC X/Y table 216 to move the length of tubing axially relatively to a machine-controlled laser as described. The entire space between collets can be patterned using a laser set-up of the foregoing example. The program for control of the apparatus is dependent on the particular configuration used and the pattern formed.

Cutting a fine structure also requires the ability to manipulate the tube with precision. CNC equipment manufactured and sold by Anorad Corporation may be used for positioning the tube. In addition, a unique rotary mechanism has been provided that allows the computer program to be written as if the pattern were being cut from a flat sheet. This allows both circular and linear interpolation to be utilized in programming. Since the finished structure of the stent is very small, a precision drive mechanism is required that supports and drives both ends of the tubular structure as it is cut. Since both ends are driven, they must be aligned and precisely synchronized, otherwise the stent structure would twist and distort as it is being cut.

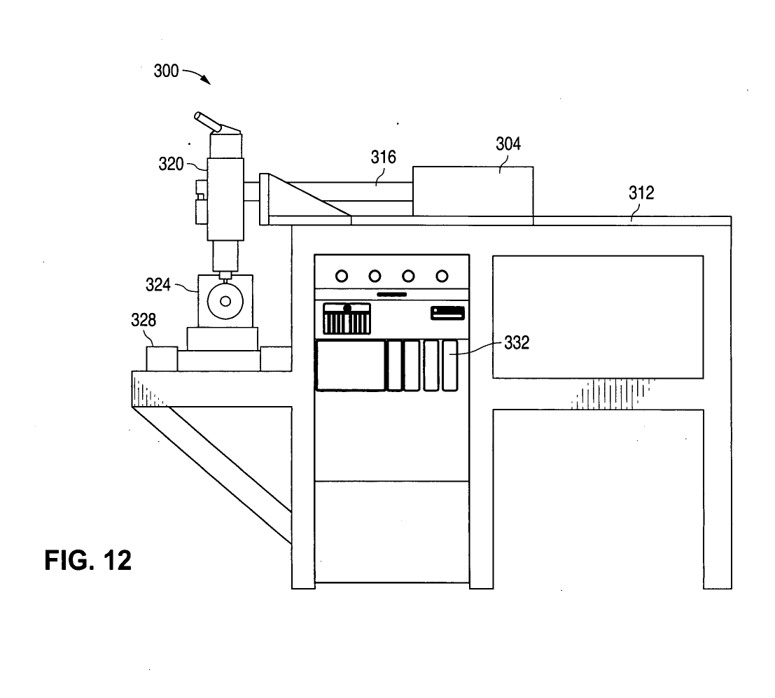

FIGS. 12-15 illustrate a process and apparatus, in accordance with the present embodiments, for producing stents with a fine precision structure cut from a small diameter thin-walled cylindrical tube. FIG. 12 depicts a side view of a laser machining apparatus 300 and FIG. 13 depicts an overhead view of apparatus 300. Cutting a fine structure (e.g., a 0.0035 inch web width (0.889 mm)) requires precise laser focusing and minimal heat input. In order to satisfy these requirements, an improved laser technology has been adapted to this micro-machining application according to the present embodiments.

FIGS. 12 and 13 show an Yb:KGW laser 304 (e.g., as shown in FIG. 6) that is integrally mounted on apparatus 300 in the area of a horizontal mounting surface 312. A pulse generator (not shown) provides restricted and precise control of the laser's output by gating a diode pump. By employing a pulse generator, laser pulses having pulse lengths between 100 and 1000 femtoseconds are achieved at a frequency range of 100 to 5000 Hz. A pulse generator can be a conventional model obtainable from any number of manufacturers.

Laser 304 operates with low-frequency, pulsed wavelengths in order to minimize the heat input into the stent structure, which prevents thermal distortion, uncontrolled burn out of the stent material, and thermal damage due to excessive heat to produce a smooth, debris-free cut. In use, a diode pump generates light energy at the proximal end of laser 304. Initially, the light energy is pulsed by the pulse generator. The pulsed light energy transmissions pass through beam tube 316 and ultimately impinge upon the workpiece.

Additionally, FIGS. 12 and 13 show that apparatus 300 incorporates a monocular viewing, focusing, and cutting head 320. A rotary axis 324 and X-Y stages 328 for rotating and translating the workpiece are also shown. A CNC controller 332 is also incorporated into apparatus 300.

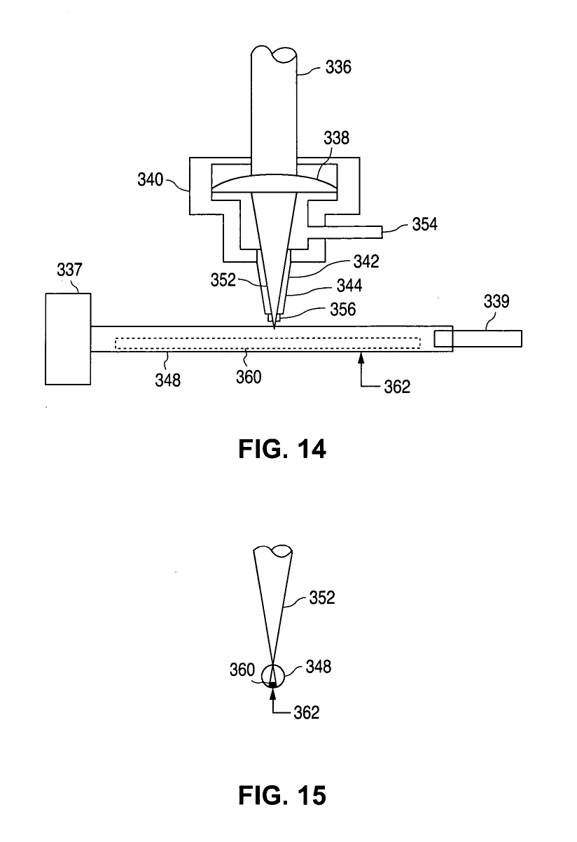

FIG. 14 depicts a close-up axial view of the region where the beam interacts with the material. A laser beam 336 is focused by a focusing lens 338 on a tube 348. Tube 348 is supported by a CNC controlled rotary collet 337 at one end and a tube support pin 339 at another end.

As shown by FIG. 14, the laser can incorporate a coaxial gas jet assembly 340 having a coaxial gas jet 342 and a nozzle 344 that helps to remove debris from the kerf and cools the region where the beam interacts with the material as the beam cuts and vaporizes a substrate. Coaxial gas jet nozzle 344 (e.g., 0.018 inch diameter (0.457 mm)) is centered around a focused beam 352 with approximately 0.010 inch (2.54 mm) between the tip of the nozzle and a tubing 348. In many cases, the gas utilized in the jets may be reactive or non-reactive (inert). In the case of reactive gas, oxygen or compressed air may be used.

In one embodiment, the jet is pressurized with oxygen at 20 psi and is directed at tube 348 with focused laser beam 352 exiting tip 356 of nozzle 344 (0.018 inch diameter (0.457 mm)). Gas input is shown by an arrow 354. The oxygen reacts with the metal to assist in the cutting process very similar to oxyacetylene cutting. The focused laser beam acts as an ignition source and controls the reaction of the oxygen with the metal. In this manner, it is possible to cut the material with a very fine kerf with precision.

In other embodiments of the present invention, compressed air may be used in the gas jet 340 since it offers more control of the material removed and reduces the thermal effects of the material itself. Inert gas such as argon, helium, or nitrogen can be used to eliminate any oxidation of the cut material. The result is a cut edge with no oxidation, but there is usually a tail of molten material that collects along the exit side of the gas jet that must be mechanically or chemically removed after the cutting operation.

In either case, it may also be necessary to block laser beam 352 as it cuts through the top surface of the tube to prevent the beam, along with the molten material and debris from the cut, from impinging on the inside opposite surface of tube 348. To this end, a mandrel 360 (e.g., approx. 0.034 inch diameter (0.864 mm)) supported by a mandrel beam block 362 is placed inside the tube and is allowed to roll on the bottom of the tube 348 as the pattern is cut. This acts as a beam/debris block protecting the far wall inner diameter. A close-up end view along mandrel beam block 362 shows laser beam 352 impinging on tube 348 in FIG. 15.

Hence, the laser of the present invention enables the machining of narrow kerf widths while minimizing the heat input into the material. Thus, it is possible to make smooth, narrow cuts in the tube 348 in very fine geometries without damaging the narrow struts that make up the stent structure.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

1. A method of fabricating a stent comprising:
providing a substrate;
providing a femtosecond laser with an Yb:KGW active medium; and
forming a pattern in the substrate with the laser, the pattern comprising a plurality of structural elements.

2. The method of claim 1, wherein the substrate comprises a generally tubular member.

3. The method of claim 1, wherein the substrate comprises sheet.

4. The method of claim 3, further comprising forming a stent from the sheet with the pattern.

5. The method of claim 1, wherein the substrate comprises a biostable metal, bioerodible metal, biostable polymer, bioabsorbable polymer, or a combination thereof.

6. The method of claim 1, the active medium is pumped by a laser diode.

7. The method of claim 1, wherein the laser pulse length is between about 100 and 1000 femtoseconds.

8. The method of claim 1, wherein the laser pulse frequency is between about 100 and 5000 Hz.

9. The method of claim 1, wherein the average laser power is between about 0.01 to about 4 Watts.

10. The method of claim 1, wherein the wavelength of the laser is 1050 nm.

11. The method of claim 1, wherein the wavelength of the laser beam is 525 nm.
